(19) United States
(12) Patent Application Publication
(10) Pub. No.: US 2008/0174635 A1
(43) Pub. Date: Jul. 24, 2008

(54) Printing apparatus, recording medium drive apparatus, and printing method

(75) Inventors: Takeshi Matsui, Tokyo (JP); Yuichiro Ikemoto, Kanagawa (JP)

Correspondence Address: WOLF GREENFIELD & SACKS, P.C., 600 ATLANTIC AVENUE, BOSTON, MA, 02210-2206, US

(73) Assignee: Sony Corporation, Tokyo (JP)

(21) Appl. No.: 12/009,219

(22) Filed: Jan. 17, 2008

(30) Foreign Application Priority Data
Jan. 19, 2007 (JP) JP2007-010075

(51) Int. Cl. B41J 2/01

(52) U.S. Cl. 347/44

(57) ABSTRACT

A printing apparatus is disclosed. The printing apparatus includes a print head and a print head rotating mechanism. The print head has a discharge portion which discharges printing ink. The print head rotating mechanism causes the print head to rotate in a state where a print target surface of a recording medium having the print target surface and the discharge portion face each other.

### CROSS REFERENCES TO RELATED APPLICATIONS

The present invention contains subject matter related to Japanese Patent Application JP 2007-010075 filed in the Japanese Patent Office on Jan. 19, 2007, the entire contents of which being incorporated herein by reference.

### BACKGROUND OF THE INVENTION

1. Field of the Invention

The present invention relates to a printing apparatus which prints characters, images, or the like on a recording medium, a recording medium drive apparatus equipped with this printing apparatus, and a printing method.

2. Description of the Related Art

In the past, many apparatuses capable of printing characters, images, or the like on an optical disk or the like have been proposed. In some cases, the above printing apparatus is incorporated into an optical disk drive apparatus (see Patent Document 1). In the drive apparatus of Patent Document 1, as shown in FIG. 5, an ink-jet print head placed facing an optical disk is moved in a radial direction of the optical disk by a dedicated seek mechanism. Printing is performed by the print head moving from an inner circumference to an outer circumference of the optical disk while the optical disk is rotated. Further, as shown in FIG. 6 of Patent Document 1, an example in which the print head is attached to an optical pickup and the print head together with the optical pickup is moved by the seek mechanism of the optical pickup is disclosed.

Furthermore, an apparatus capable of printing by linear movement of a head above a disk at a position off a center of the disk is disclosed (see Patent Document 2, for example). In this apparatus of Patent Document 2, the disk is not rotated during printing. Accordingly, printing is performed only at a predetermined position in a radial direction of the disk instead of printing on the whole area of a single side of the disk.

(Patent Document 1)

Japanese Patent Application Laid-Open No. 2002-46305 (paragraphs [0036], [0043], [0044], FIG. 5, FIG. 6)

(Patent Document 2)

Japanese Patent Application Laid-Open No. 2006-315413 (paragraph [0031], FIG. 3)

### SUMMARY OF THE INVENTION

In the apparatus of Patent Document 1, the width of printing on the optical disk is determined according to the width of the print head (width in a longitudinal direction of an ink discharge portion). The larger this width is, the wider the region to be printed per one rotation of the optical disk becomes. Accordingly, the larger the width is, the higher the print speed becomes.

It is assumed here that the above print head with a large width is used, for example, for the apparatus described in Patent Document 2. In this case, the print width is large, which causes an unused portion in the discharge portion of the print head as shown in FIG. 12 of Patent Document 2. Hence, the print head with a small width offers increased efficiency and miniaturization of the print head itself, which is advantageous.

In view of the above circumstances, it is desirable to provide a printing apparatus capable of increasing the print speed and realizing miniaturization of a print head, a recording medium drive apparatus, and a printing method.

According to an embodiment of the present invention, there is provided a printing apparatus including a print head and a print head rotating mechanism. The print head has a discharge portion which discharges printing ink. The print head rotating mechanism causes the print head to rotate in a state where a print target surface of a recording medium having the print target surface and the discharge portion face each other.

In the embodiment of the present invention, the rotation of the print head by the print head rotating mechanism causes rotation of the discharge portion. In other words, the discharge portion rotates in a plane substantially parallel to the print target surface. Consequently, the width of a print image (characters or an image to be printed) can be properly controlled, which enables high-speed printing as well as miniaturization of the print head.

“In a state where the print target surface and the discharge portion face each other” refers to a state where the ink is discharged from the discharge portion to enable printing on the print target surface.

According to the embodiment of the present invention, the printing apparatus further includes a moving mechanism and an angle control means. The moving mechanism linearly moves the print head in the state where the print target surface and the discharge portion face each other. The angle control means controls a rotation angle of the print head according to a position of the print head moved by the moving mechanism. Namely, the rotation angle of the print head is controlled according to the position of the print head with respect to the print target surface. This enables a variety of printing according to the position above the print target surface.

According to the embodiment of the present invention, the recording medium is a circular plate-shaped disk, and the moving mechanism moves the print head on a straight line not passing a center of the disk. Hence, for example, utilizing the linear movement of the disk when the disk is ejected, the printing can be performed locally at a position which is not on a straight line passing the center of the disk. On the other hand, in the embodiment of the present invention, the effect produced by the control of the rotation angle of the print head according to the position of the print head by the angle control means is further enhanced. In particular, if it is assumed that the print head is not rotated when the printing is performed while the disk is rotating, the width of a region to be printed on the print target surface (width in a radial direction of the disk) changes depending on the position of the print head with respect to the print target surface. However, the rotation of the print head enables printing with the same width regardless of the position above the print target surface, and for example, in the case of printing on the whole area of the print target surface, high-speed printing becomes possible.

For example, the printing apparatus further includes a moving mechanism control means. The moving mechanism control means controls driving of the moving mechanism so that printing is performed when the disk is rotating in the state where the print target surface and the discharge portion face each other. The discharge portion is provided extending in one direction. The angle control means controls the rotation angle so that when the print head is being moved by the moving mechanism, a width in a direction orthogonal to a circumferential direction of the rotation of the disk of a region on which the printing is performed becomes constant. Consequently, as described above, the printing can be performed with the same print width regardless of the position above the print target surface.

According to the embodiment of the present invention, the angle control means has a first engaging portion provided on the print head, and a second engaging portion, engageable with the first engaging portion, to rotate the print head by the movement of the print head by the moving mechanism while engaging with the first engaging portion. In the embodiment of the present invention, the rotation corresponding to the movement of the print head is mechanically performed, so a special control circuit, software, and the like become unnecessary.

According to the embodiment of the present invention, the print head performs printing when the recording medium is linearly moving in the state where the print target surface and the discharge portion face each other. Hence, the printing can be locally performed on the print target surface by appropriately changing the print width. Alternatively, according to the embodiment of the present invention, the print head may perform the printing when the recording medium is carried by a carrier included in a recording medium drive apparatus and loaded into or unloaded from a main body of the recording medium drive apparatus.

A recording medium drive apparatus according to an embodiment of the present invention includes a rotation drive mechanism, a print head, and a print head rotating mechanism. The rotation drive mechanism holds and causes a recording medium having a print target surface to rotate. The print head has a discharge portion which discharges printing ink. The print head rotating mechanism causes the print head to rotate in a state where the print target surface of the recording medium and the discharge portion face each other.

A printing method according to an embodiment of the present invention includes causing a print target surface of a recording medium having the print target surface and a discharge portion of a print head having the discharge portion which discharges printing ink to face each other, and rotating the print head in a state where the print target surface and the discharge portion face each other.

As described above, according to the embodiments of the present invention, it is possible to increase the print speed and realize the miniaturization of the print head.

### BRIEF DESCRIPTION OF DRAWINGS

FIG. 1 is a perspective view showing an optical disk drive apparatus according to an embodiment of the present invention;

FIG. 2 is a perspective view showing the internal structure of the optical disk drive apparatus shown in FIG. 1;

FIG. 3 is a plan view showing the internal structure of the optical disk drive apparatus shown in FIG. 2;

FIG. 4 is a perspective view showing part of a printing unit;

FIG. 5 is a schematic side view showing a guide rail and a guide pin;

FIG. 6 is a perspective view of a print head and a print head rotating mechanism viewed from the back side;

FIG. 7 is a perspective view of the print head and the print head rotating mechanism viewed from the lower side;

FIG. 8 is a schematic sectional view showing the print head rotating mechanism;

FIG. 9 is a block diagram showing the constitution of the optical disk drive apparatus;

FIG. 10 is a flowchart showing the operation of the printing unit;

FIGS. 11A and 11B are schematic views showing the operation of unloading printing in sequence;

FIG. 12 is a view of a disk showing an example in which text data as print data is printed on the disk;

FIG. 13 is a schematic view showing an operation in which the print head is moved while being rotated;

FIG. 14 is a schematic view showing the operation when the print head is not rotated when moved on a straight line not passing a center of the disk;

FIG. 15 is a schematic view showing an angle control mechanism of a print head rotating mechanism according to another embodiment of the present invention;

FIG. 16 is a schematic view showing a modified example of the angle control mechanism shown in FIG. 15;

FIG. 17 is a view showing the disk on which an image is printed by disk rotation printing;

FIG. 18 is a perspective view showing a slot-in type optical disk drive apparatus; and

FIG. 19 is a perspective view showing a print head in which an ink tank and a discharge portion are integrated.

### DESCRIPTION OF PREFERRED EMBODIMENTS

Embodiments of the present invention will be described below with reference to the drawings.

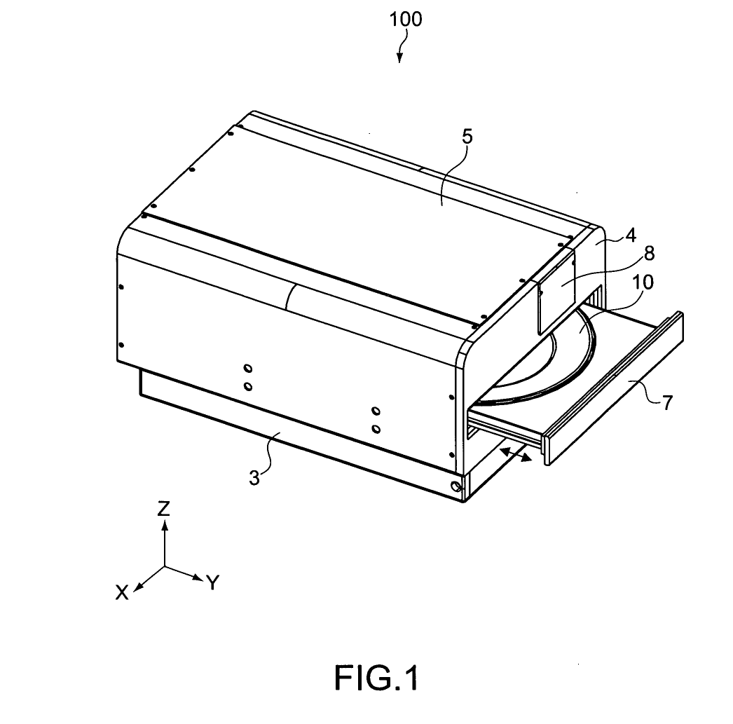

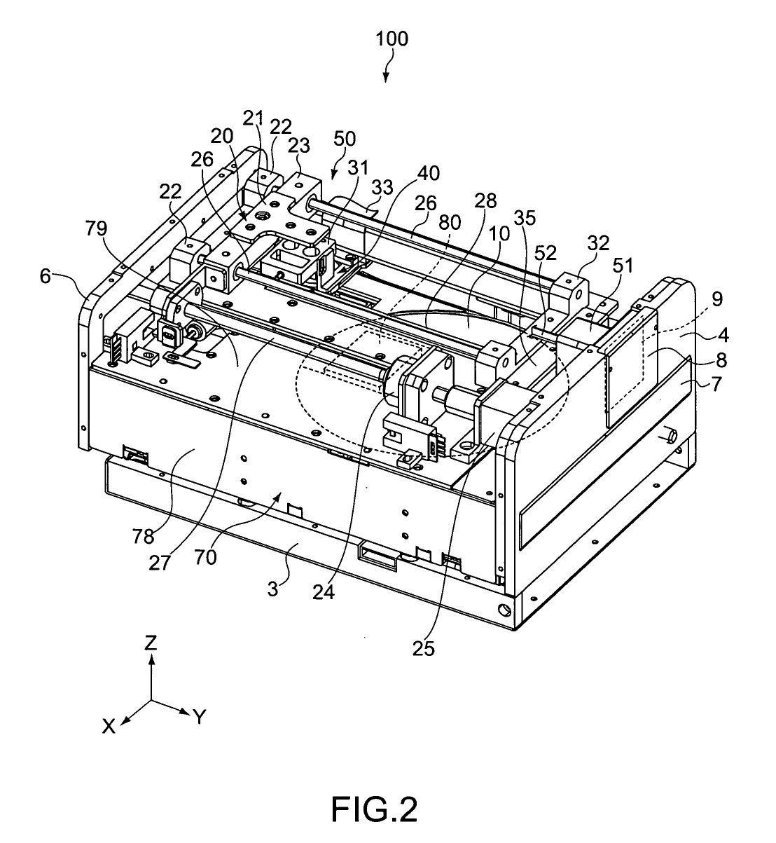

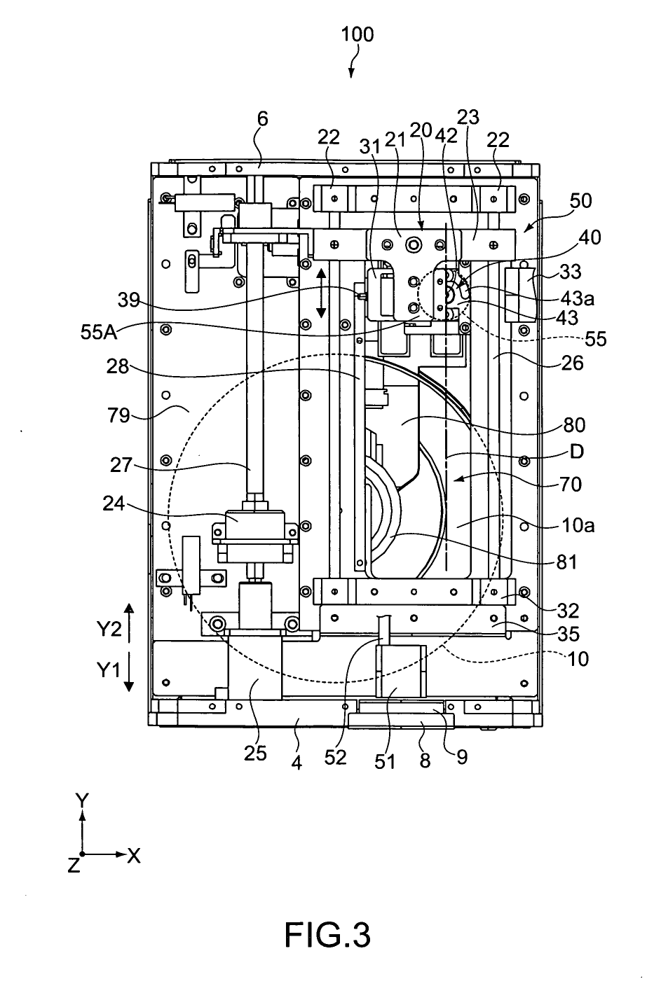

FIG. 1 is a perspective view showing an optical disk drive apparatus as a recording medium drive apparatus according to an embodiment of the present invention. FIG. 2 is a perspective view showing the internal structure of an optical disk drive apparatus 100 shown in FIG. 1. FIG. 3 is a plan view showing the internal structure of the optical disk drive apparatus 100 shown in FIG. 2. Incidentally, in FIG. 2 and FIG. 3, an electric circuit board, wiring, and other mechanisms and so on unrelated to the present invention are not shown.

The optical disk drive apparatus 100 is an apparatus which at least optically records a signal on a disk-shaped recording medium (hereinafter referred to only as a disk) 10 or reproduces a recorded signal.

Examples of the disk 10 include a CD (Compact Disc), a DVD (Digital Versatile Disc), a BD (Blu-Ray Disc (registered trademark)), an HD (High Definition)-DVD, a disk using near-field light, a disk using a hologram, an MO (Magneto Optical), and an MD (Mini-Disk). Further, particularly, a bare DVD, a bare BD, a bare disk using near-field light, a bare disk using a hologram, or the like is sometimes housed in a cartridge.

Not only the optical disk drive apparatus, but also an apparatus driving a recording medium constituted by a solid-state memory is conceivable as the recording medium drive apparatus. As a solid-state memory 73, a recording medium such as a semiconductor memory, a dielectric memory, or a magnetic material memory is conceivable.

The optical disk drive apparatus 100 includes a base 3, a recording/reproducing unit 70 mounted on the base 3, and a printing unit 50 placed on top of the recording/reproducing unit 70. The recording/reproducing unit 70 is covered with a side cover 78 and an upper cover 79. The recording/reproducing unit 70 has a disk tray 7 as a carrier which carries the disk 10 while the disk 10 is mounted thereon. The disk tray 7 can be moved with the disk 10 mounted thereon in a forward/backward direction (Y direction) by a loading mechanism not shown. A front panel 4 is provided on the front side of the optical disk drive apparatus 100, and a back panel 6 is provided on the back side thereof. Further, the optical disk drive apparatus 100 includes an external cover 5 which is detachable from the base 3, the front panel 4, the back panel 6, or the like and covers an internal mechanism of the optical disk drive apparatus 100. In the following description, the front panel 4 side is called the front side and the back panel 6 side is called the back side.

The disk tray 7 is moved, for example, by the above loading mechanism placed under the disk tray 7. Under the disk tray 7, an optical pickup 80 having an objective lens, an actuator, and so on and a thread mechanism (not shown) which moves this optical pickup 80 in a radial direction (Y direction in the figures) of the disk 10 are placed. The loading mechanism and the thread mechanism can be variously structured and, for example, may have well-known structures.

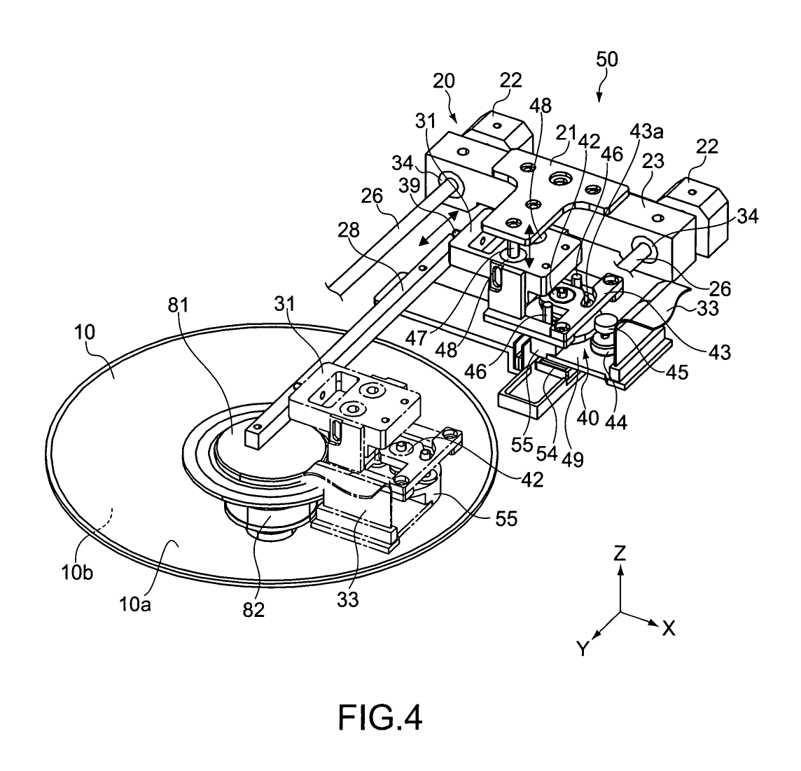

FIG. 4 is a perspective view mainly showing part of the printing unit 50. As shown in FIG. 3 and FIG. 4, the disk 10 is fixed by a chucking plate 81 so as to be sandwiched between the chucking plate 81 and a spindle motor 82. The chucking plate 81 is attached to a suitable frame member not shown.

The printing unit 50 (printing apparatus) is placed on top of the recording/reproducing unit 70. With reference to FIG. 2 to FIG. 4, the printing unit 50 includes a print head 55 capable of being placed so as to face a print target surface 10a of the disk 10 and a print head rotating mechanism 40 which has a holder 43 holding the print head 55 and causes the print head 55 to rotate at a predetermined angle. The print head rotating mechanism 40 will be described later. The print target surface 10a of the disk 10 is, for example, part or all of a surface on the opposite side of a signal recording surface 10b (surface facing the optical pickup 80 side) of the disk 10, and a surface on which ink can be fixed.

The printing unit 50 includes a vertically moving block 31 coupled to the holder 43 and a vertical guide shaft 47 inserted through a linear bearing 48 provided in the vertically moving block 31 and guides the movement of the vertically moving block 31 in a vertical direction (Z direction).

The printing unit 50 includes a moving mechanism 20 linearly moving the print head 55 in a horizontal direction (Y direction, for example). The moving mechanism 20 has a horizontally moving block 23, horizontal guide shafts 26 inserted through linear bearings 34 provided in the horizontally moving block 23, a drive motor 25 to be a source of power to move the horizontally moving block 23, and a ball screw 27 connected to the drive motor 25 via a coupling 24 and connected to the horizontally moving block 23. Further, the above vertical guide shaft 47 and horizontally moving block 23 are coupled by a coupling plate 21. Both ends of the horizontal guide shafts 26 are respectively fixed by fixing blocks 22 and 32, and the fixing blocks 22 and 32 are fixed to frame plates 35. By the moving mechanism 20 thus constituted, the print head 55 is moved between a standby position 55A on the back side and, for example, a nearly middle position in the Y direction of the disk 10 chucked by the chucking plate 81. When viewed in the plane of FIG. 3, the standby position 55A is provided outside a region where the disk 10 is placed. A dead center position on the front side of the print head 55 may not be the nearly middle position in the Y direction of the disk 10, but may be a position on the further front side from the middle position.

At the standby position 55A, an ink collector 54 which collects the ink discharged from the print head 55 is placed (see FIG. 4). The ink collector 54 is provided to remove bubbles mixed into the ink, or the like, by discharging the ink from the print head 55 into the ink collector 54, for example, before print processing. This ink collector 54 also functions as a cap of the print head 55.

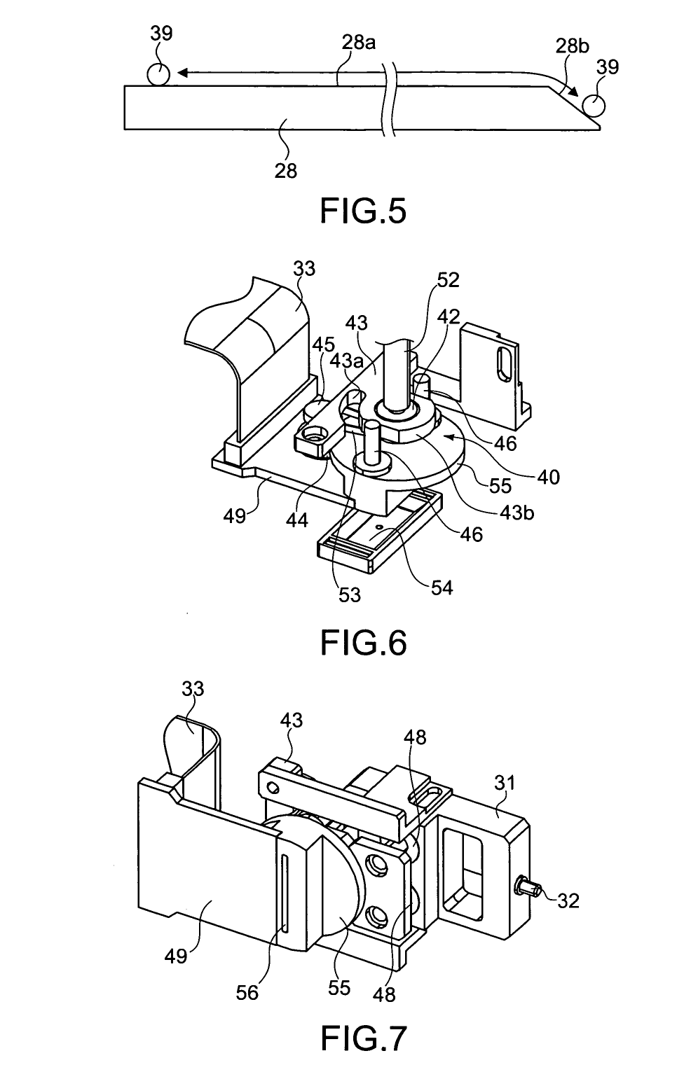

A guide pin 39 is provided on a side surface of the vertically moving block 31. The guide pin 39 engages with a guide rail 28 extending in a moving direction of the horizontally moving block 23. FIG. 5 is a schematic side view showing the guide rail 28 and the guide pin 39. The guide pin 32 is mounted, for example, on an upper surface 28a of the guide rail 28 and moves along the upper surface 28a of the guide rail 28 according to the horizontal movement of the horizontally moving block 23.

Further, a slope 28b is provided at an end portion of the guide rail 28 on the back side thereof. The guide pin 32 moves on the slope 28b, so that the vertically moving block 31 moves in the vertical direction by a distance corresponding to the movement of the guide pin 32 on the slope 28b. The print head 55 is moved up and down by this up-and-down movement of the vertically moving block 31, and the print head 55 accesses the ink collector 54, for example, by the downward movement of the print head 55.

Incidentally, the moving mechanism in the vertical direction by the vertically moving block 31 may be constituted, for example, by a mechanism including a motor or the like instead of this guide pin 32.

As shown in FIG. 2 and FIG. 3, a printing ink tank 51 is placed on the front side of the printing unit 50. A supply tube 52 having flexibility and supplies ink from the ink tank 51 to the print head 55 is connected between the ink tank 51 and the print head 55. The flexibility of the supply tube 52 is realized, for example, by forming the supply tube 52 itself from a flexible resin. Alternatively, the supply tube 52 having a bellows may be used. For example, a user can replace the ink tank 51 via an opening 9 provided in the front panel 4 by opening and closing a cover 8 detachable from the opening 9.

FIG. 6 is a perspective view of the print head 55 and the print head rotating mechanism 40 viewed from the back side. FIG. 7 is a perspective view of the print head 55 and the print head rotating mechanism 40 viewed from the lower side. Incidentally, in FIG. 7, the vertically moving block 31 not shown in FIG. 6 is also shown.

As shown in FIG. 7, the print head 55 has at its lower portion an ink discharge portion 56 facing the print target surface 10a of the disk 10. The discharge portion 56 is of a shape extending in one direction and is provided with plural small discharge ports along the longitudinal direction. The number of rows of discharge ports may be one or plural. The print head 55 is, for example, an ink-jet head, and has a built-in ink discharging actuator or bubble generating heating device which is not shown. The print heat 55 is placed so that the longitudinal direction of the discharge portion 56 is oriented in the Y direction. The print head 55 mostly stands by at the standby position 55A shown in FIG. 3 when the print processing is not performed.

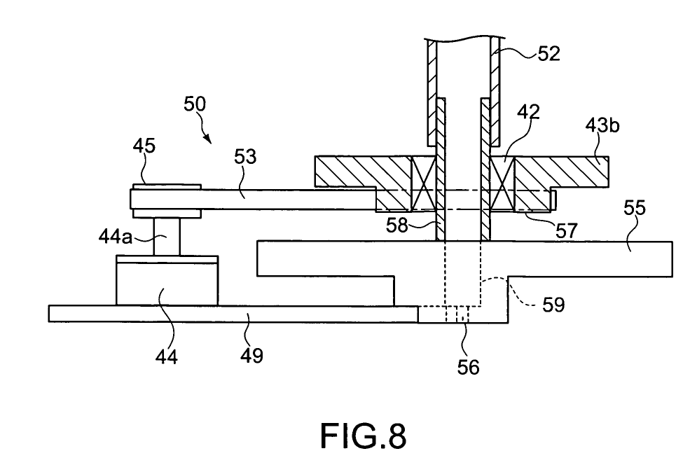

FIG. 8 is a schematic sectional view showing the print head rotating mechanism 40. The print head rotating mechanism 40 has a rotary motor 44 mounted on a printed-circuit board 49. An output shaft 44a of the rotary motor 44 is provided with a drive pulley 45, and a driven pulley 57 is connected to the drive pulley 45 via a timing belt 53. A connecting pipe 58 connected to the supply tube 52 is provided on top of the print head 55, and a region inside the connecting pipe 58 communicates with an ink channel 59 which leads to the discharge portion 56 inside the print head 55. The connecting pipe 58 is inserted through a bearing 42 fitted to a bearing fitting portion 43b. The driven pulley 57 is provided integrally with the bearing fitting portion 43b of the holder 43.

The printed-circuit board 49 includes a drive circuit driving the above ink discharging actuator (or heating device) and a drive circuit for the rotary motor 44. An angle control means is constituted by at least the rotary motor and these drive circuits. Incidentally, as shown in FIG. 6, FIG. 7, and so on, a flexible substrate 33 is connected to the printed-circuit board 49.

Owing to the above constitution of the print head rotating mechanism 40, the connecting pipe 58, the print head 55, the printed-circuit board 49, and the flexible substrate 33 rotate integrally. The rotation of the print head 55 causes rotation of the discharge portion 56. In other words, the discharge portion 56 rotates in a plane substantially parallel to the print target surface 10a.

In the print head rotating mechanism 40, a drive system using the timing belt 53 is used in FIG. 8, but a gear drive system or any other drive system may be used. The constitution of the print head 55 is not limited to the constitution shown in FIG. 8, and various changes in shape, size, and so on may be made therein.

As shown in FIG. 6, for example, two pins 46 protrude from an upper surface of the print head 55. In the holder 43, a cutout 43a is formed as a restriction portion which restricts the movement of the pin 46 caused by the rotation of the print head 55. For example, when the print head 55 is rotated 90 degrees clockwise from the state shown in FIG. 3, the pin 46 comes into contact with the cutout 43a, and the further rotation of the print head 55 is restricted. FIG. 4 shows a state where the print head 55 which has been moved to the front side by the moving mechanism 20 is rotated 90 degrees.

Incidentally, in this embodiment, the pin 46, the cutout 43a which restricts the pin 46, and so on are not indispensable, and for example, the rotation of the print head 55 may be restricted by controlling the driving of the rotary motor 44. Further, when the pin 46 is to be provided, the number of pins may be one.

As shown in FIG. 3, the print head 55 is placed so that the discharge portion 56 of the print head 55 moves on a straight line D indicated by a dashed line at a position offset from the center of the disk 10, that is, a position not passing the center of the disk 10. As just described, the print head 55 can be situated on the straight line D not passing the center of the disk 10, so as described later, in a state where the disk 10 is mounted on the disk tray 7, printing can be performed utilizing the movement of the disk 10 when the disk tray 7 is ejected.

Moreover, by placing the print head 55 on the straight line D as just described, the degree of freedom in design can be improved, for example, compared to such placement design that the print head 55 passes above the center of the disk 10.

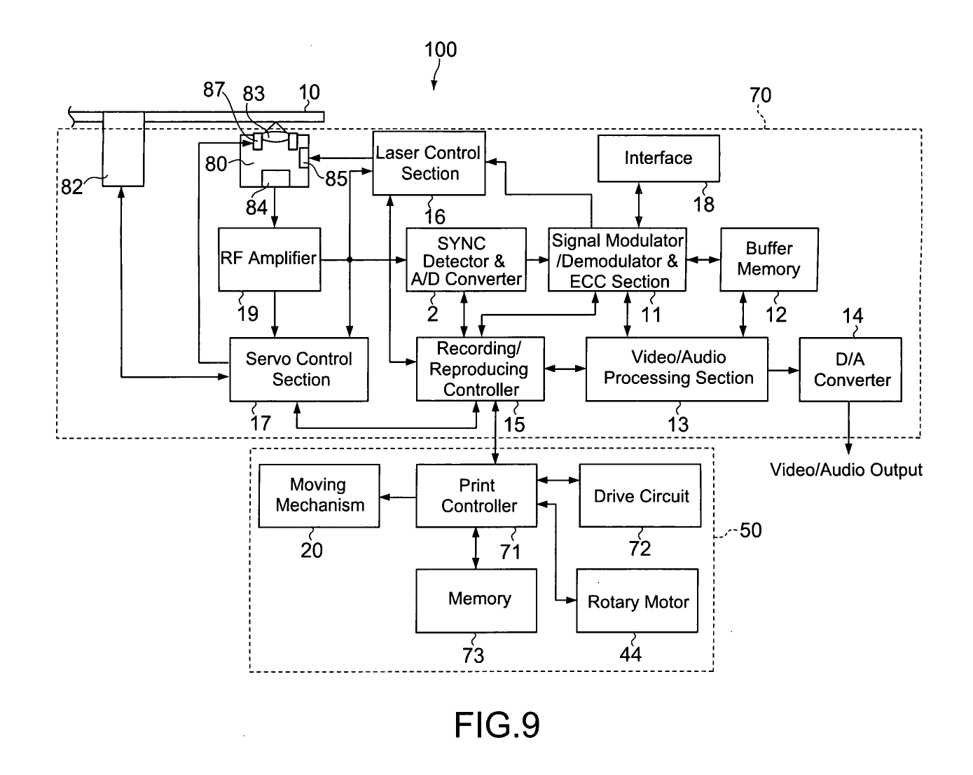

FIG. 9 is a block diagram showing the constitution of the optical disk drive apparatus 100.

The recording/reproducing unit 70 of the optical disk drive apparatus 100 includes the above spindle motor 82, the above optical pickup 80, an RF amplifier 19, a three-axis actuator 87, and a servo control section 17.

The spindle motor 82 functions as a rotation drive mechanism for rotating the disk 10. The optical pickup 80 includes a laser light source 85, an objective lens 83 which collects laser light emitted from the laser light source 85 on the disk 10, a photodetector (PD) 84 which detects reflected return light from the disk 10, and so on. For example, a semiconductor laser, particularly a laser diode (LD) is used as the laser light source 85, but the laser light source 85 is not limited to the above. The optical pickup 80 additionally includes an optical system not shown to guide the laser light emitted from the laser light source 85 to the objective lens 83, and so on. The RF amplifier 19 generates a focus error signal, a tracking error signal, an RF signal, and so on based on various signals outputted from the PD 84 of the optical pickup 80. The three-axis actuator 87 moves particularly the objective lens 83 portion of the optical pickup 80 in a tracking direction, a focusing direction, and a tilt direction. The servo control section 17 outputs various servo signals to the three-axis actuator 87 and the spindle motor 82 based on the focus error signal, the tracking error signal, and the RF signal.

Further, the recording/reproducing unit 70 includes a thread motor not shown to move the optical pickup 80 in the radial direction of the disk 10. The servo control section 17 also outputs the servo signals to the thread motor.

The recording/reproducing unit 70 includes a recording/reproducing controller 15, a laser control section 16, a synchronous detector & A/D converter 2, a signal modulator/demodulator & ECC (Error Correction Code) section 11, a buffer memory 12, a video/audio processing section 13, a D/A converter 14, and an interface 18.

The recording/reproducing controller 15 receives inputs of and outputs various signals to collectively control the entire recording/reproducing unit 70. The laser control section 16 receives a modulation signal from the signal modulator/demodulator & ECC section 11 and modulates laser power of the laser light source 85 to write the signal into the disk 10 and controls the laser power based on the RF signal. The synchronous detector & A/D converter 2 further generates clocks based on synchronous signals recorded on the disk 10 at predetermined intervals and converts an analog signal into a digital signal. The signal modulator/demodulator & ECC section 11 performs signal modulation/demodulation, addition of an ECC, and error correction processing based on the ECC. The buffer memory 12 temporarily stores data during the processing in the signal modulator/demodulator & ECC section 11. The video/audio processing section 13 performs necessary video processing and audio processing and outputs video and audio in an analog form via the D/A converter 14. The interface 18 is an interface to connect an external computer, video/audio sources, and so on not shown.

The printing unit 50 includes a print controller 71, the above moving mechanism 20, a drive circuit 72 for the print head 55, and a memory 73 which stores data on print information being information on print contents (hereinafter referred to as print data). The print controller 71 receives an input of a signal from the recording/reproducing controller 15 and outputs a signal to the recording/reproducing controller 15. Further, the print controller 71 controls the moving mechanism 20 and the drive circuit 72. The drive circuit 72 is a circuit mounted in the above printed-circuit board 49. The memory 73 temporarily stores the print data, for example, from a PC, a memory card, or any other external device. Furthermore, the print controller 71 controls driving of the above rotary motor 44.

In data recording, digital data inputted from the external computer not shown to the interface 18 is modulated after an error correction code is added thereto in the signal modulator/demodulator & ECC section 11. Based on the modulated data, a pulse is generated by the laser control section 16 and the laser light is irradiated to the disk 10 via the optical pickup 80, whereby the data is recorded. During the data recording, servo control is properly performed by the servo control section 17.

On the other hand, in data reproduction, when the laser light is irradiated to the disk 10, its return reflected light is detected by the PD 84. The reflected light detected by the PD 84 is amplified, subjected to waveform equalization, and the like in the RF amplifier 19 to reproduce the RF signal, and a bit string obtained by binarizing the RF signal is generated by the synchronous detector & A/D converter 2. The generated bit string is subjected to signal demodulation and error correction by the signal modulator/demodulator & ECC section 11. The demodulated signal is separated by the video/audio processing section 13 into video data and audio data, which are then subjected to D/A conversion and outputted in an analog form. During the data reproduction, servo control is properly performed by the servo control section 17.

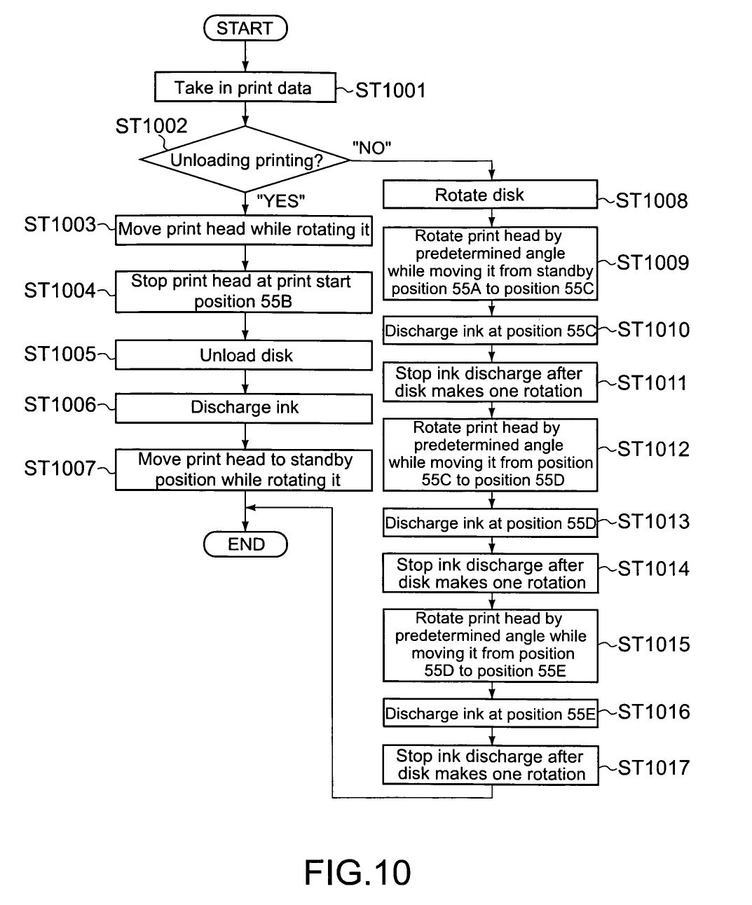

Next, the operation of the printing unit 50 will be described. FIG. 10 is a flowchart showing this operation.

The print data, for example, from the PC, the memory card, or any other external device is taken into the print controller 71 (step 1001). When the print data is taken in, the print controller 71 temporarily stores the print data in the memory 73, and starts the print processing. In this embodiment, there are two print processings: unloading printing of performing printing utilizing the movement of the disk 10 when the disk tray 7 is ejected, that is, at the time of unloading; and disk rotation printing of performing printing while the disk 10 is being rotated. The user only needs to select one of these two print processings. This selection can be implemented by displaying a selection mode screen for selecting either of the print processings, for example, on a display section included in the optical disk drive apparatus 100 or an electronic device in which the optical disk drive apparatus 100 is mounted. In this case, it is only necessary for the user to be able to make the selection via a remote control, an operation button, a touch panel, or any other input interfaces while viewing the selection mode screen.

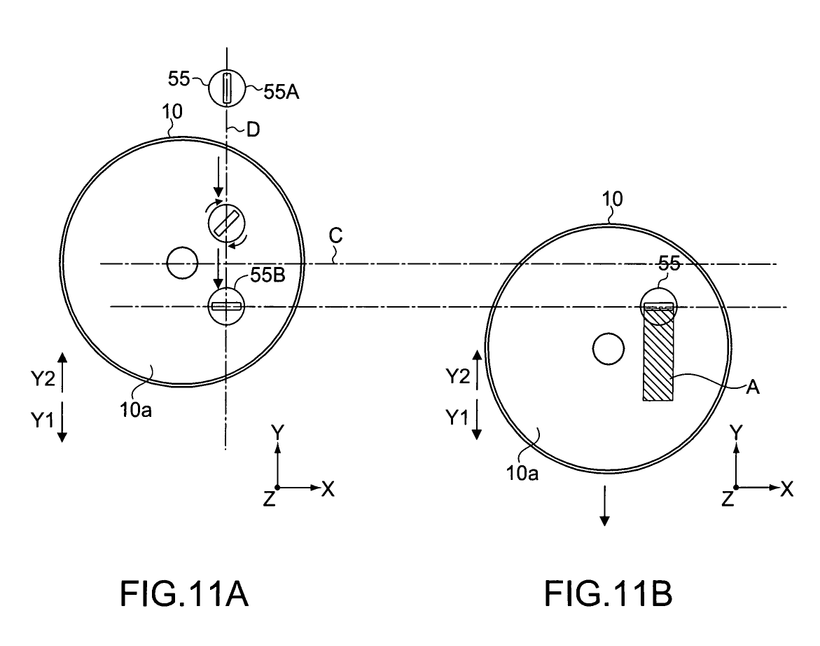

In the case of the unloading printing (YES in step 1002), as shown in FIG. 11A, the print head 55 is moved from the standby position 55A to the front side (in a Y1 direction) by the moving mechanism 20 according to control of the print controller 71. Here, the direction of the movement from the back side to the front side is referred to as Y1 direction, and its opposite direction is referred to as Y2 direction. At this time, the print head 55 is moved while being rotated by the print head rotating mechanism 40 according to driving of the drive circuit 72 (step 1003). When moved to a position at a slightly front side from a middle position C of the disk 10 in the Y direction (hereinafter called a print start position 55B) according to control of the print controller 71, the print head 55 is stopped there (step 1004). The print head 55 is rotated about 90 degrees while being moved from the standby position 55A to the print start position 55B.

Incidentally, in addition to the form in which the print head 55 is rotated while being moved from the standby position 55A to the print start position 55B, forms of the following cases are conceivable. For example, there are a case where when the print head 55 is rotated while staying at the standby position 55A, a case where the print head 55 is rotated while staying at the print start position 55B, and so on. Further, in the case where the print head 55 is rotated while being moved, the timing when the rotation starts during the movement may be at any position.

In the state where the print head 55 is stopped at the print start position 55B, the ejection, that is, unloading operation of the disk 10 is performed according to control of the recording/reproducing controller 15 (step 1005). As shown in FIG. 11B, in the unloading operation, the disk tray 7 moves in the Y1 direction. During the movement of the disk tray 7, the ink is discharged from the print head 55 according to the print data by control of the print controller 71 (step S1006). Consequently, printing is performed locally on a predetermined region A of the print target surface 10a of the disk 10.

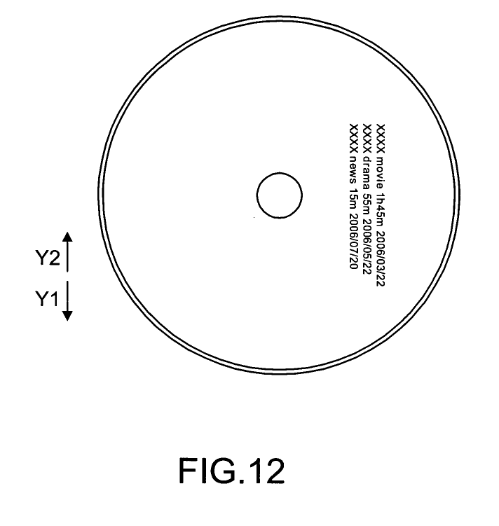

FIG. 12 shows an example in which text data as the print data is printed on the disk 10. Needless to say, in the unloading printing, not only characters but also a picture, a photograph, or the like can be printed.

When the unloading operation is completed, the print head 55 is moved to the standby position while being rotated by driving of the moving mechanism 20 and the drive circuit 72 according to control of the print controller 71 (step 1007). Thus, the unloading printing is completed. Incidentally, depending on the contents of the print data, for example, the amount of the print data is sometimes small, or the operation of step 1007 is sometimes started before the unloading operation is completed.

On the other hand, when the unloading printing is not selected in step 1002, that is, the disk rotation printing is selected, the disk 10 is rotated by the spindle motor 82 according to control of the recording/reproducing unit 70 (step 1008). In this embodiment, a case where the print target surface 10a of the disk 10 is the almost whole area of the surface of the disk 10 is cited as an example, and a case where printing is performed on the whole area will be described. The rotation frequency of the disk 10 in the disk rotation printing is several tens to several hundreds of rpm, which is low-speed rotation. However, the rotation frequency is not limited to this range. In the case of the disk rotation printing, original print data is subjected to polar coordinate transformation processing and printed as described above.

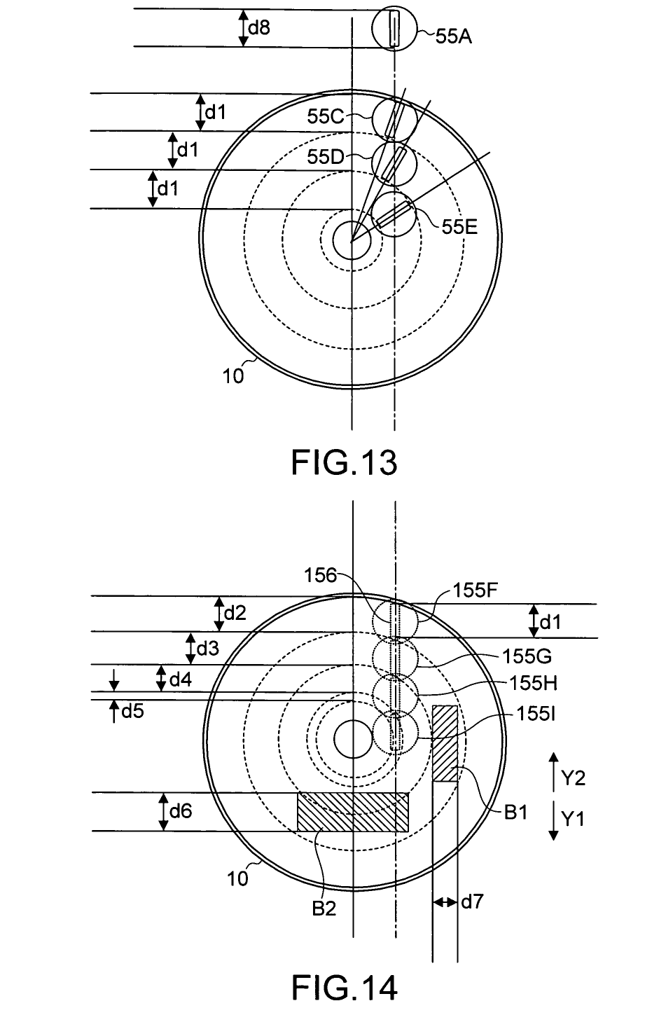

As shown in FIG. 13, the print head 55 is moved from the standby position to a position 55C (outer peripheral side of the disk 10) according to control of the print controller 71, and during the movement, rotated until its rotation angle becomes a predetermined angle (step 1009). The rotation angle in this case is such that the longitudinal direction of the discharge portion 56 of the print head 55 is a direction substantially matching the radial direction of the disk 10. The print head 55 discharges the ink at the position 55C (step 1010). When printing on an appropriate region of the disk 10 ends after the start of the discharge of the ink at the position 55C, the print head 55 stops the discharge of the ink according to control of the print controller 71 (step 1011).

Then, according to control of the print controller 71, the print head 55 is moved from the position 55C to a position 55D, and during the movement, rotated until its rotation angle becomes a predetermined angle (step 1012). The print head 55 discharges the ink at the position 55D (step 1013). When printing on an appropriate region of the disk 10 ends after the start of the discharge of the ink at the position 55D, the print head 55 stops the discharge of the ink according to control of the print controller 71 (step 1014).

Similarly, the print head 55 is moved from the position 55D to a position 55E (inner peripheral side of the disk 10) while being rotated, and discharges the ink to perform printing (steps 1015 to 1017).

While the print head 55 is moved from the position 55C to the position 55D and from the position 55D to the position 55E, the disk 10 may be rotated or stopped. In particular, when the disk 10 is rotated while the print head 55 is moved, the print controller 71 receives position information in a rotational circumferential direction of the disk 10 at the position 55C as the print start position from the recording/reproducing controller 15. This is because the discharge start positions of the ink at the position 55C to the position 55E match in the circumferential direction. For example, the recording/reproducing controller 15 or the print controller 71 has only to generate respective timing signals for the start of discharge of the ink at the position 55C to the position 55E based on the synchronous signals recorded on the signal recording surface 10b of the disk 10, output signals of a rotary encoder of the spindle motor 82, or the like.

As described above, in this embodiment, the print head 55 is rotated by the print head rotating mechanism 40, so that the width of a print image can be properly controlled, which enables high-speed printing as well as miniaturization of the print head 55. In particular, as shown in FIG. 13, at the position 55C to the position 55E, printing can be performed with substantially the same width d1.

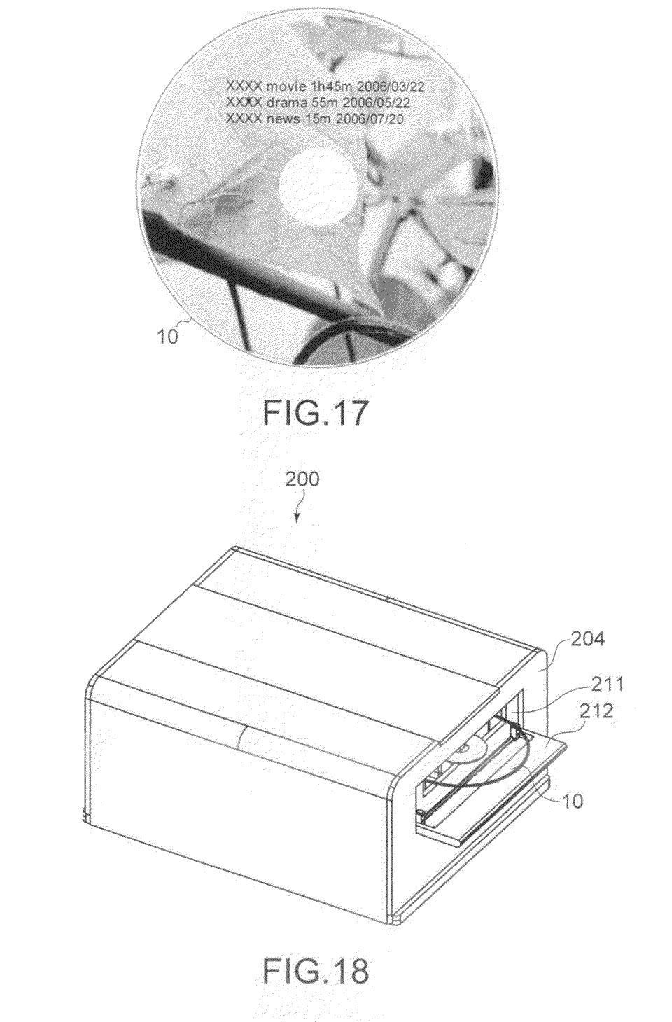

FIG. 17 is a view showing the disk 10 on which an image and characters are printed by the disk rotation printing. In this disk rotation printing, the original print data can be printed by being subjected to the polar coordinate transformation. Incidentally, in FIG. 17, the local character portion can also be printed by the unloading printing.

Further, in this embodiment, also in local printing, it is, of course, possible to perform the printing while properly changing the width of the print image. In the local printing of the unloading printing, the printing can be performed with the angle of the discharge portion 56 of the print head 55 in an oblique direction instead of the Y direction and X direction. This makes it possible, for example, to angle and obliquely print characters and graphics by mechanical control independently of control of the drive circuit 72, thereby enabling a variety of printing.

For example, FIG. 14 is a view showing a print region for each rotation of the disk 10 when the print head 55 is not rotated when the print head 55 is moved on the straight line not passing the center of the disk 10. In this example, a print head 155 is moved from a position 155F on the outer peripheral side of the disk 10 to a position 155I, and repeats the discharge and stop of the ink every time the disk 10 makes one rotation. In this case, compared to the example shown in FIG. 13, the print width becomes gradually narrower in the order of d2→d3→d4→d5, and the ink density (print density) becomes higher in that order. For appropriate printing at a constant print density without the rotation of the print head 55, special control may become necessary. Further, for printing on the almost whole area of the surface of the disk 10 in FIG. 14, the disk 10 may need to make at least four rotations. However, in the example shown in FIG. 13, the disk 10 has only to make three rotations, so the whole-area printing at high speed becomes possible.

Now, a case where, in the example in which the print head 55 is not rotated as shown in FIG. 14, local printing such as those shown in FIG. 11B and FIG. 12 is performed is considered. More specifically, in FIG. 14, a case where printing is performed on two local regions of a region B1 with a print width d7 and a region B2 with a print width d6 is considered. Here, the width of a discharge portion 156 of the print head 155 is represented as d1, and d7<d1<d6 is assumed. In this case, when printing is locally performed on the region B1, the printing becomes possible if the print head 55 is at a position 155G. However, when printing is locally performed on the region B2, the print head 55 may need to be at the position 155G and a position 155H, and therefore the disk 10 needs to make two rotations. In contrast, in this embodiment, since the print head 55 is rotatable, high-speed printing is possible with a width d8 (see FIG. 13) of the discharge portion 56 of the print head 55 as a maximum width when the disk 10 is unloaded.

Incidentally, in this embodiment, in the case of local printing in which the print width based on the print data exceeds d8, it is only necessary to perform the disk rotation printing.

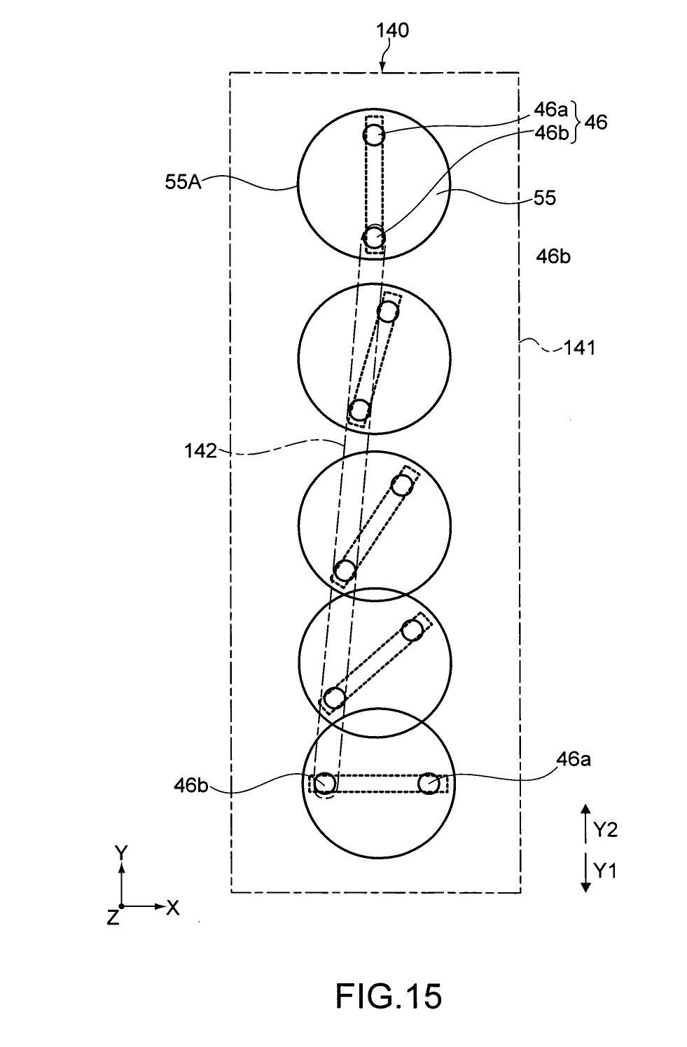

FIG. 15 is a schematic view showing an angle control mechanism (angle control means) of the print head rotating mechanism 40 according to another embodiment of the present invention. This angle control mechanism 140 includes a guide plate 141 having a guide groove (second engaging portion) 142 engaging with one pin 46b out of two pins (first engaging portion) 46 (46a and 46b) provided at the upper surface of the print head 55.

The guide groove 142 is formed so that the print head 55 gradually changes its rotation angle as the print head 55 is moved in the Y direction. In this example, the print head 55 at the standby position 55A is moved toward the Y1 direction while being rotated clockwise. In this case, as shown in FIG. 13, the guide groove 142 has only to be formed so that the print head 55 is moved in such a manner that the radial direction of the disk 10 and the longitudinal direction of the discharge portion 56 substantially match regardless of its position above the disk 10.

Since two pins 46 are provided, two guide grooves 142 corresponding thereto may also be provided in the guide plate 141. Alternatively, as described above, the number of pins 46 may be one.

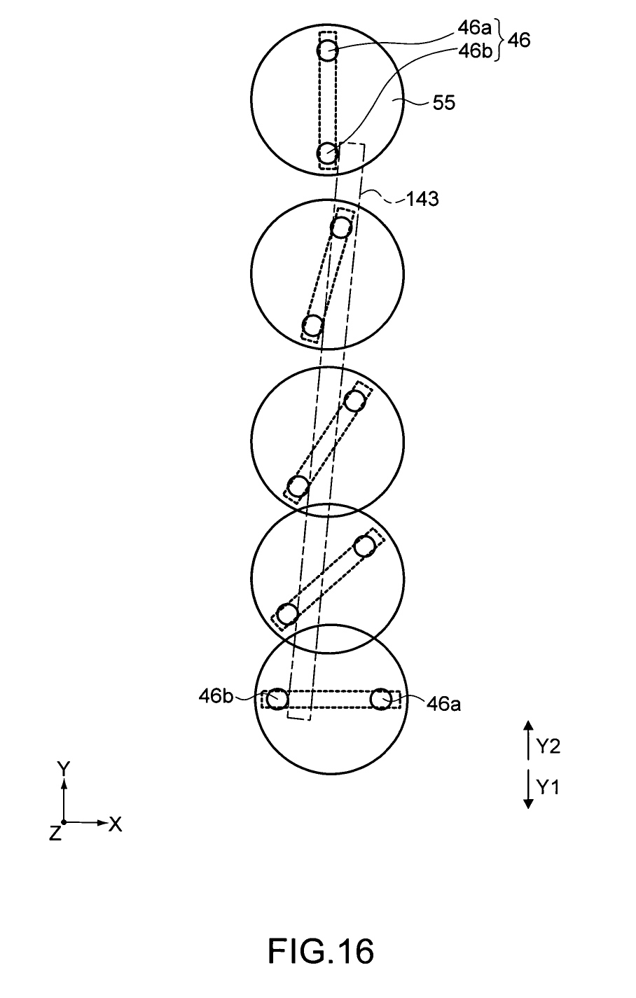

FIG. 16 is a schematic view showing a modified example of the angle control mechanism shown in FIG. 15. This angle control mechanism has a guide rail 143 engaging with the pin 46b out of the pins 46 on the print head 55. The manner of the operation of the print head 55 is the same as in the case of FIG. 15.

According to the angle control mechanism shown in FIG. 15 and FIG. 16, the rotation according to the movement of the print head 55 is mechanically performed, so a special control circuit, software, and the like become unnecessary.

In the embodiment shown in FIG. 15 and FIG. 16, the form in which the print head 55 is rotated 90 degrees at maximum is shown, but a form in which it is rotated by an angle exceeding 90 degrees at maximum or rotated by an angle smaller than 90 degrees at maximum may also be employed.

Embodiments according to the present invention are not limited to the embodiments described above, and various other embodiments are conceivable.

In the above embodiments, as shown in FIG. 1, the disk-tray type optical disk drive apparatus 100 is described. However, as shown in FIG. 18, a slot-in type optical disk drive apparatus 200 may be used. In this apparatus, an opening 211 is provided on a front panel 204, and the disk 10 is inserted and ejected while a slot cover 212 is opened. When, as just described, the disk 10 is ejected, that is, unloaded, the local printing becomes possible. Of course, also in this optical disk drive apparatus 200, the local printing at the time of loading and the disk rotation printing are possible.

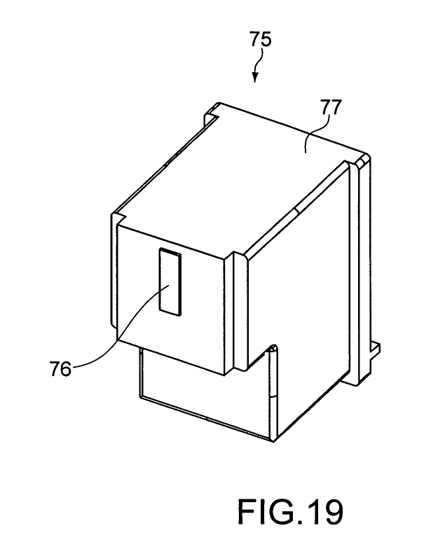

The print head is not limited to the form shown in FIG. 6, FIG. 7, and so on, and for example, a print head 75 such as that shown in FIG. 19 in which an ink tank 77 and a discharge portion 76 are integrated is also suitable.

In the above embodiments, the print head 55 is placed so that at the standby position 55A, the longitudinal direction of the discharge portion 56 is oriented in the Y direction. However, the print head 55 may be placed so that at the standby position 55A, the longitudinal direction of the discharge portion 56 is oriented in the X direction. In this case, in the unloading printing, while being moved from the standby position 55A to the print start position 55B, the print head 55 can keep its posture as it is without being rotated.

In the above embodiments, the region where the print head 55 is linearly moved is a region on the straight line D not passing the center of the disk 10. However, the region where the print head 55 is linearly moved may be a region on a straight line passing the center of the disk 10. In this case, the print region by the local printing when the disk 10 is unloaded is the region on the straight line passing the center of the disk 10, for example, a region on both sides or one side of a hole for chucking at the center of the disk 10.

In the above embodiments, in steps 1003 to 1007 of FIG. 10, the form in which the printing is performed when the disk 10 is unloaded is shown, but the printing may be performed when the disk 10 is loaded.

In the above embodiments, the form in which the discharge portion 56 is of a shape extending in one direction is shown. However, the discharge portion 56 may have a shape close to a square. In other words, the discharge portion 56 structured such that discharge ports are arranged in a matrix having almost the same number of rows and columns instead of being arranged in one row to several rows is also suitable. Even in the print head 55 having such a discharge portion 56, it is only necessary for the print head 55 to be rotated properly according to its position above the print target surface 10a of the disk 10.

It should be understood by those skilled in the art that various modifications, combinations, sub-combinations and alterations may occur depending on design requirements and other factors insofar as they are within the scope of the appended claims or the equivalents thereof.

1. A printing apparatus, comprising:
a print head having a discharge portion which discharges printing ink; and
a print head rotating mechanism rotating the print head in a state where a print target surface of a recording medium having the print target surface and the discharge portion face each other.

2. The printing apparatus as set forth in claim 1, further comprising:
a moving mechanism linearly moving the print head in the state where the print target surface and the discharge portion face each other; and
an angle control means for controlling a rotation angle of the print head according to a position of the print head moved by the moving mechanism.

3. The printing apparatus as set forth in claim 2,
wherein the recording medium is a circular plate-shaped disk, and
wherein the moving mechanism moves the print head on a straight line not passing a center of the disk.

4. The printing apparatus as set forth in claim 3, further comprising
a moving mechanism control means for controlling driving of the moving mechanism so that printing is performed when the disk is rotating in the state where the print target surface and the discharge portion face each other,
wherein the discharge portion is provided extending in a first direction, and
wherein the angle control means controls the rotation angle so that when the print head is being moved by the moving mechanism, a width of a region on which the printing is performed becomes constant in a second direction orthogonal to a circumferential direction of the rotation of the disk.

5. The printing apparatus as set forth in claim 3,
wherein the angle control means includes:
a first engaging portion provided on the print head; and
a second engaging portion, engageable with the first engaging portion, to rotate the print head by the movement of the print head by the moving mechanism while engaging with the first engaging portion.

6. The printing apparatus as set forth in claim 1,
wherein the print head performs printing when the recording medium is linearly moving in the state where the print target surface and the discharge portion face each other.

7. The printing apparatus as set forth in claim 6,
wherein the print head performs the printing when the recording medium is carried by a carrier included in a recording medium drive apparatus and loaded into or unloaded from a main body of the recording medium drive apparatus.

8. A recording medium drive apparatus, comprising:
a rotation drive mechanism holding and rotating a recording medium having a print target surface;
a print head having a discharge portion which discharges printing ink; and
a print head rotating mechanism rotating the print head in a state where the print target surface of the recording medium and the discharge portion face each other.

9. A printing method, comprising:
causing a print target surface of a recording medium having the print target surface and a discharge portion of a print head having the discharge portion which discharges printing ink to face each other; and
rotating the print head in a state where the print target surface and the discharge portion face each other.
